(19) United States
(12) Patent Application Publication
(10) Pub. No.: US 2017/0107678 A1
(43) Pub. Date: Apr. 20, 2017

(54) Secure space barrier

(71) Applicant: Jose J. Floran Rivera, Bayamon, PR (US)

(72) Inventor: Jose J. Floran Rivera, Bayamon, PR (US)

(21) Appl. No.: 14/885,019

(22) Filed: Oct. 16, 2015

(51) Int. Cl. E01F 13/04; E05F 13/02

(52) U.S. Cl. CPC E01F 13/042; E05F 13/02

(57) ABSTRACT

A space barrier for preventing the unauthorized use of reserved spaces comprising a vertical locking mechanism and a raising mechanism. The raising mechanism comprising at least a pedal-like component welded to a push up member for displacing in a rotational matter the space barrier from a horizontal position to a vertical position. The raising mechanism is useful for avoiding lower back injuries or for assisting user with lower back injuries. Further the locking mechanism assist the parking barrier to hold the vertical position while avoiding the entry or exit of a vehicle from the parking space.

### CROSS-REFERENCE TO RELATED APPLICATION

N/A

### STATEMENT REGARDING FEDERALLY SPONSORED RESEARCH AND DEVELOPMENT

N/A

### BACKGROUND OF THE INVENTION

Field of the Invention

The present disclosure relates to space barrier devices, more particularly to a retractable space barrier installed at the entrance of a space wherein said space barrier is easily operated and secured so as to prevent others from using a private or reserved space.

Discussion of the Background

Unfortunately, reserve spots/spaces tend to be occupied by unauthorized users unless a guard or parking attendant is present. In an attempt to prevent unauthorized uses of reserved spaces, it has been proposed to provide at least barrier devices which normally block such reserved spaces, and which can be selectively moved to a non-blocking position only by a person authorized to do so.

Usually the devices used for reserving spaces are set in the ground within the determined area of the space and include a swingable portion which may be pivoted from a substantially horizontal position adjacent to the ground in which the vehicle can pass over the barrier to a substantially vertical position in which it blocks entry or exit of a vehicle from the space.

One of the disadvantages of the current barriers is the fact that a person needs to bend in order to pull up the barrier to put it in a vertical position. Another disadvantage is the use of an efficient locking mechanism in order to hold the barrier in position, more particularly in a vertical position.

Therefore there is a need to provide a space barrier installed in a space having a raising mechanism which is easily operated and secured so as to prevent others from using a private or reserved space.

### SUMMARY OF THE INVENTION

The object of the present invention is to provide a simple and inexpensive space barrier that can be easily raised and lowered by an authorized user to provide access to an assigned space.

Specifically, it is an object of this invention to provide a space barrier device that is set into the pavement or ground level outside the space and which will prevent unauthorized entry into the space.

It is a further object of the invention to provide a space barrier device that may be locked against swinging motion by a non-authorized person.

To enable a better understanding of the objectives and features of the present disclosure, a brief description of the drawing below will be followed by a detailed description of the invention.

### BRIEF DESCRIPTION OF THE DRAWINGS

FIG. 1 shows a general view the first exemplary space barrier guarding a space in accordance with the principles of the present disclosure.

FIG. 2 shows a general view of preferred displacement of the first exemplary space barrier embodiment in accordance with the principles of the present disclosure.

FIGS. 3A-3B show general views of the first exemplary space barrier embodiment in vertical position in accordance with the principles of the present disclosure.

FIGS. 4A-4C show detail views of the first exemplary space barrier embodiment in vertical position in accordance with the principles of the present disclosure.

FIGS. 5A-5D show general views of the preferred displacement of the locking bar mechanism in accordance with the principles of the present disclosure.

FIGS. 6A-6B show general views of the first exemplary space barrier embodiment in transitional position in accordance with the principles of the present disclosure.

FIGS. 7A-7D show detail views of the first exemplary space barrier embodiment in vertical position in accordance with the principles of the present disclosure.

FIGS. 8A-8B show perspective views of the first exemplary space barrier embodiment in horizontal position in accordance with the principles of the present disclosure.

FIGS. 9A-9D show detail views of the first exemplary space barrier embodiment in horizontal position in accordance with the principles of the present disclosure.

FIGS. 10A-10C are detail views of the actuator of the first preferred embodiment in vertical position in accordance with the principles of the present disclosure.

FIGS. 11A-11B are perspective views of exemplary structure applying the first preferred embodiment in accordance with the principles of the present disclosure.

### DETAILED DESCRIPTION OF THE INVENTION

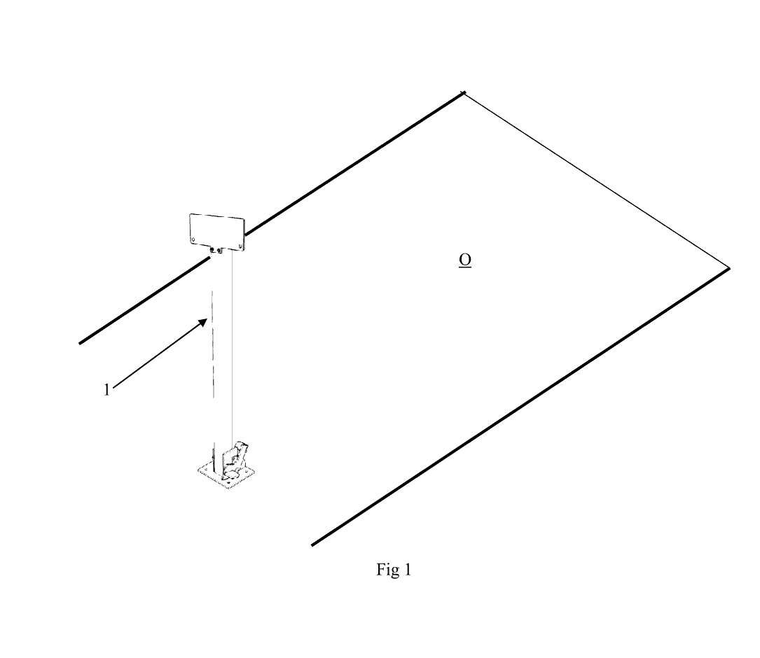

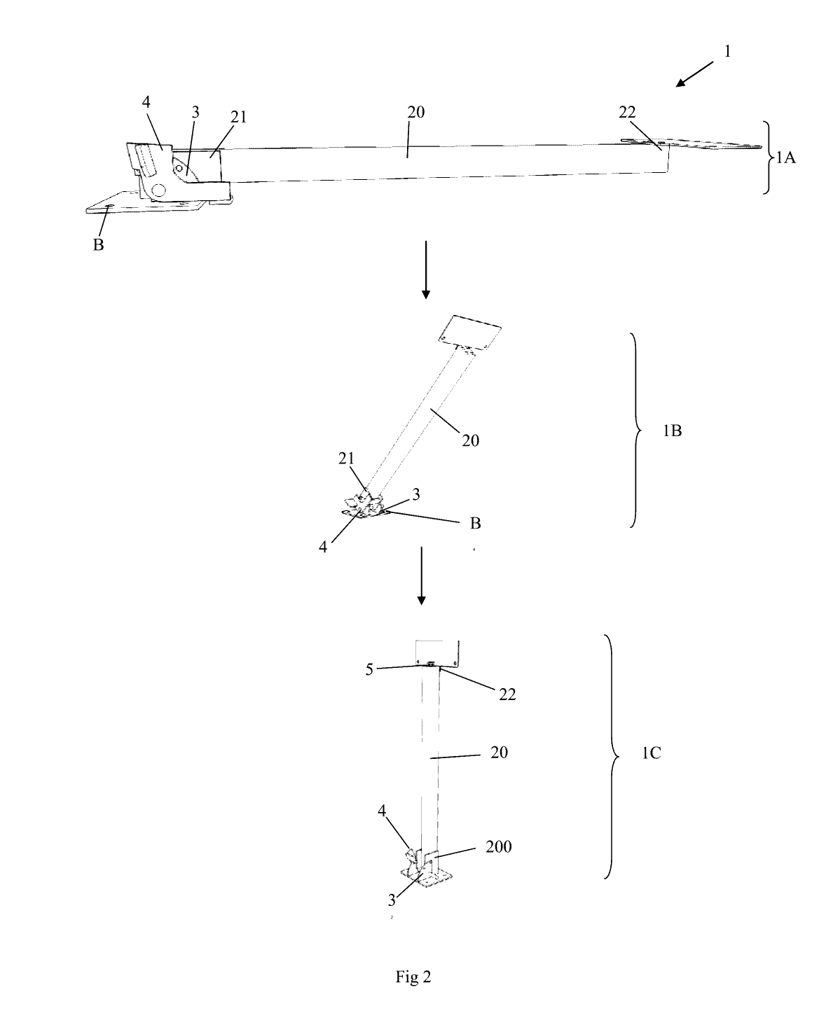

As shown in FIG. 1, the barrier 1 is intended to provide protection to an open space O while being configured to provide access when needed. The barrier 1 used for reserving a space comprises a base B, a display D, a main body or housing 20, a locking bar mechanism 5, a pivot member 3 and an actuator 4. The barrier 1 is intended to be positioned at a horizontal position to permit access to the open space O and a vertical position to avoid access to the open space O. FIG. 2 shows the process of the barrier 1 moving from the horizontal position 1A, to a transitional position 1B and ending in the vertical position 1C. The barrier 1 is intended to comprise a main body 20, wherein said main body 20 comprises a first distal end 21 and a second distal end 22. The material used for the barrier 1 is preferred to be a material that withstand variable weather conditions, such as hot weather, snow, dust and rain. Further main body 20 comprises a hollow main body and the at least said first distal end 21 is mechanically coupled to said pivot member B1. The second distal end 22 of said main body 20 comprises a display plate D. The display plate D comprises at least a recess to attach any desired member through said recess D1.

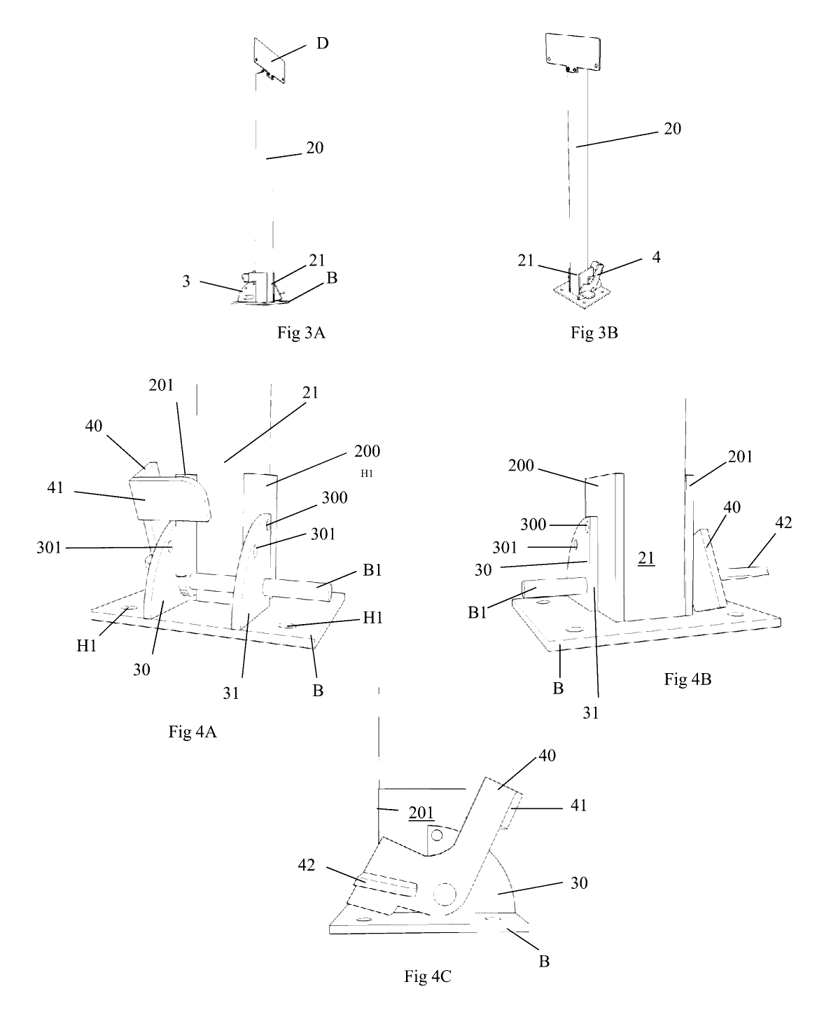

The main body 20, as shown in FIG. 3A trough 3B, is intended to achieve a vertically position with respect to the base B and floor. The base B, which is preferred to be fixed to the floor, supports the pivot member 3 which is attached to said base B. The pivot member 3, as shown in FIG. 4A through 4C, comprises at least two vertical elements 30, 31 fixed to base B and said vertical elements extends perpendicular to the base B or floor. At least one of the two vertical elements 30, 31 comprises holes 301, 300. The holes 301, 300 are configured to provide a locking feature depending on the position of the main body 20. The dimension of the two vertical elements 30, 31 extended perpendicular to the base B. Specifically the height and length of the two vertical elements 30, 31, depends on the dimensions of the main body 20. For example, when the main body 20 is in horizontal position, as shown below, the main body 20 rests on top of the floor or base B, wherein the height of at least one two vertical elements extends vertically away from the main body 20. Further when the main body 20 is in vertical position, as shown in FIG. 4A, with respects to the floor or base B, the length of at least one of the two vertical elements extends horizontally away from the main body 20. In the instant case the first hole 301 is away from the main body 20 in order to provide enough space to engage a locking device, such as a padlock L. Therefore one of the purposes of the extension of the vertical elements 30, 31 is to provide a locking mechanism for the horizontal position and vertical position of the main body 20.

The pivot member 3 further comprises a pivot element B1 that is mechanically coupled to the first distal end 21 of the main body 20. The first distal end 21 comprises at least connection plates 200, 201 with perforations that allow the pivot element B1 to pass through. In the present disclosure the term “mechanical coupled” refers to a coupling between both parts maintaining a continuous connection while allowing a radius displacement or rotational motion of at least one of the elements. In the instant case the main body 20 is coupled to the pivot member 3 by means of the pivot element B1. The pivot element B1 maintains a continuous connection between the pivot member 3 and the first distal end 21 but at the same time allows the radius displacement of the main body 20 in such way that a horizontal and vertical position of the main body 20 is achieved. The main body 20 is configured to provide a shape that wherein it is placed in vertical position rests on top of the base or floor B, as show in FIG. 3B. The vertical elements 30, 31 are separated at a distance that is plenty to fit the first distal end 21 between said vertical elements 30, 31. The actuator 4 is further mechanically coupled to at least one of the vertical elements 30, 31 by means of said pivot element B1, as show in FIG. 4C. The actuator 4, which is explained below, comprises a pedal-plate element 42, a fixing plate 40 and a pull-plate element 41.

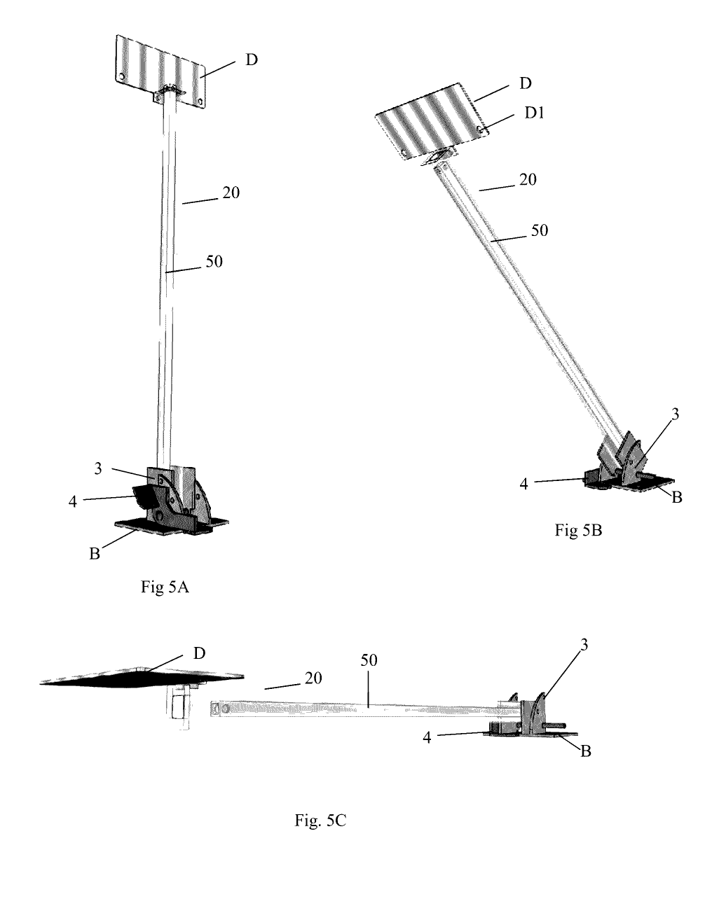

The locking bar mechanism 5, as shown in FIGS. 5A through 5D, comprises an extended locking bar 50 and a pivot locking mechanism 500. The extended locking bar 50 is positioned inside the main body 20 hollow body. The extended locking bar 50 is mechanically coupled to the pivot locking mechanism 500 by means of a second pivot element B2. The pivot locking mechanism 500 allows the radius displacement of the extended locking bar 50 simultaneously with the main body 20 displacement. The pivot locking mechanism 500 comprises a protrusion P. The protrusion P is vertically extended with respect to the base B. The protrusion P is located on top of the base B at a position that allows the main body 20 to rest on top of the floor while it is in horizontal position and to be covered by the main body 20 while it is in vertical position, as shown in FIG. 5A through 5C.

The extended locking bar 50 comprises a first end 51 and a second end 52, wherein said second end 51 includes at least a hole R, as shown in FIG. 5D. The extended locking bar 50 is configured to extend away from the main body 20 during the vertical position, as shown in FIGS. 5A and 5D. The extension of the extended locking bar 50 is the result of the protrusion P extension with respect to the base B, as shown in exploded view of FIG. 5D. Due to the configuration and arrangement of the protrusion P, the extension of the main body 20 surrounds the extended locking bar 50 while it is positioned in the horizontal position. However, the extension of said extended locking bar 50, more particularly said second end 52 extends away from the main body 20 providing a second location wherein the main body 20 is locked in said vertical position.

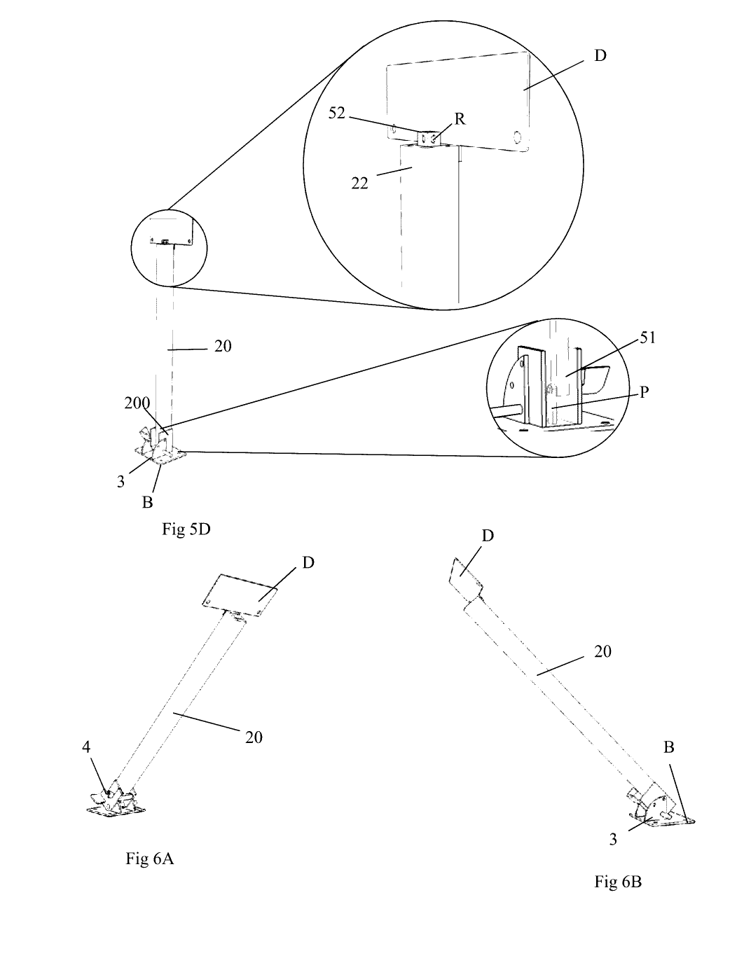

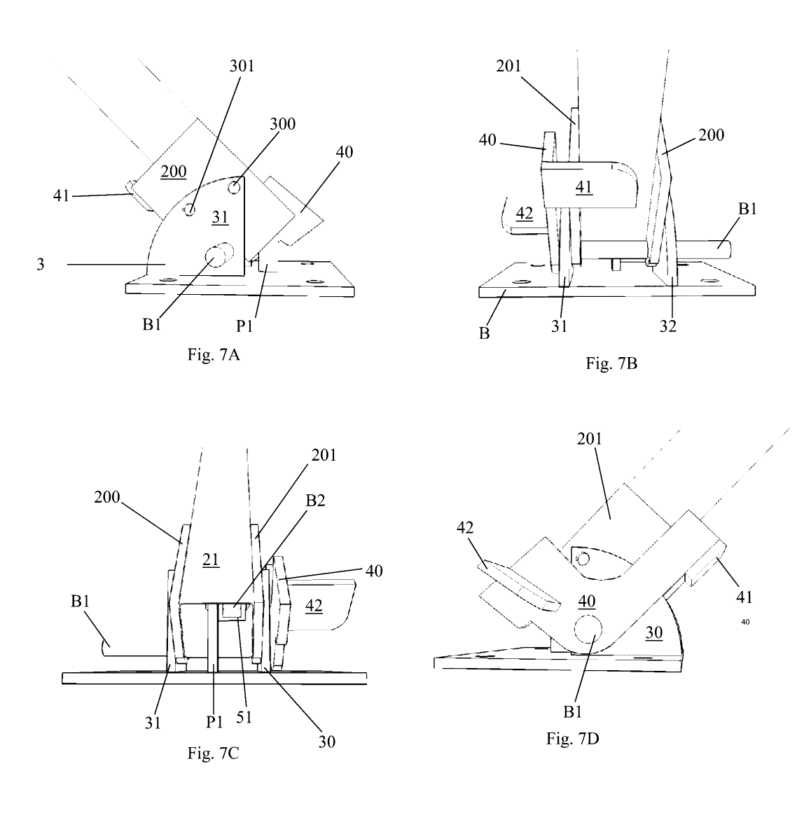

FIGS. 6A and 6B are directed to the transitional position of the space barrier 1. The displacement of the main body 20 is assisted by an actuator 4, as defined below. During the transitional position the actuator 4 pushes up the main body 20 by means of the pull-plate element 41. As shown in FIGS. 7A through 7D, the main body 20 is located between the vertical elements 30, 31 wherein said pull-plate element 41 contacts the main body 20 and pushes it up providing a radius displacement. The pivot element B1, which is mechanically coupled to the base B by means of the vertical elements 30, 31, assists to avoid vertical or horizontal displacement of the main body 20, with respects to the base B and the actuator 4, therefore allowing the rotational movement of both pieces.

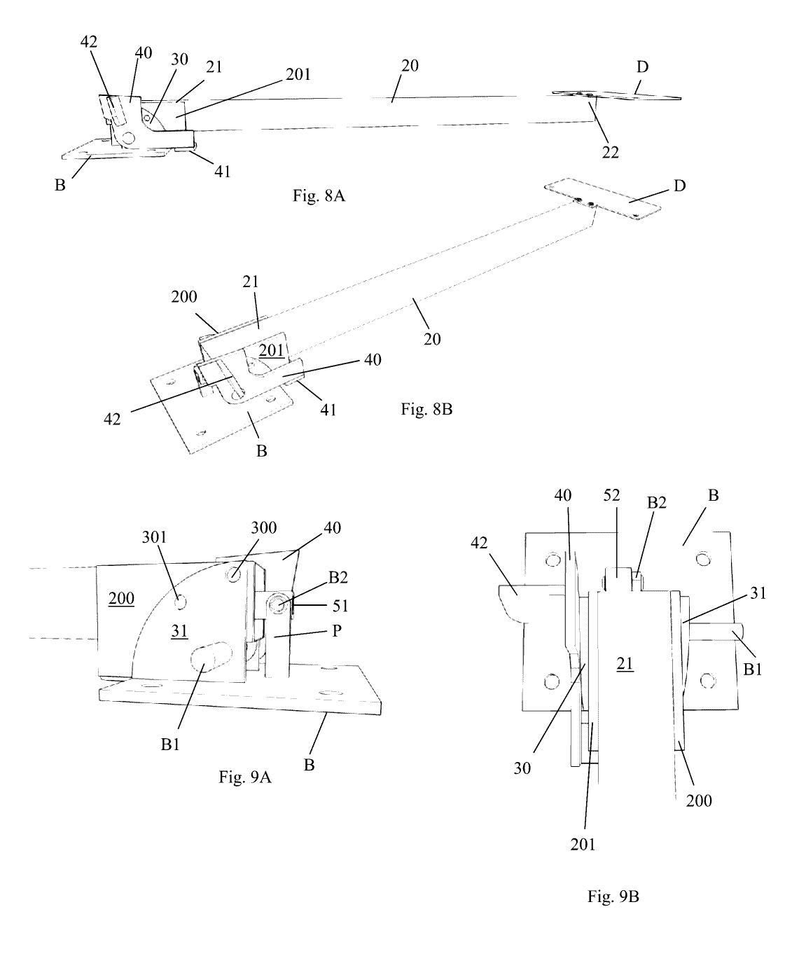

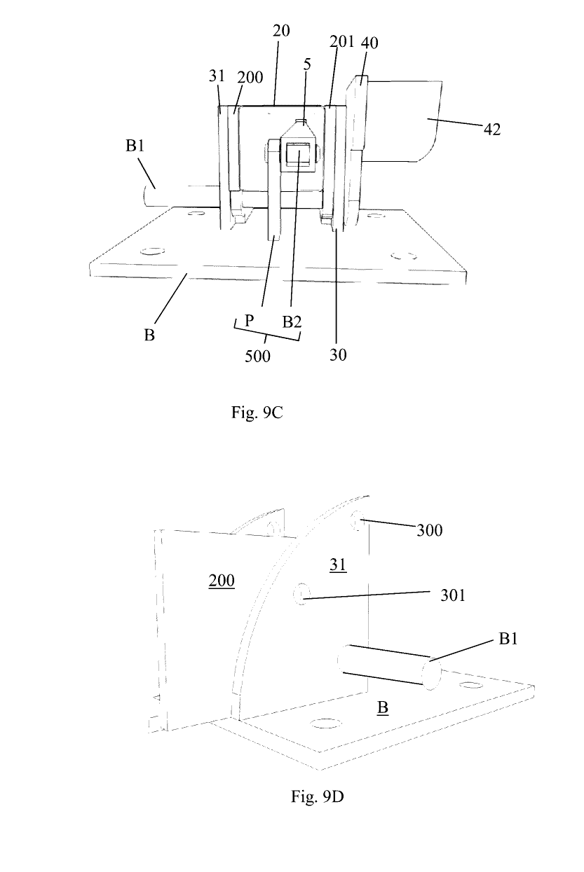

FIGS. 8A and 8B are directed to the horizontal position of the space barrier 1. As mentioned, the displacement of the main body 20 is assisted by an actuator 4. During the horizontal position the actuator 4 is resting under the main body 20. As shown in FIGS. 9A through 9D, the main body 20 is located between the vertical elements 30, 31 wherein said pull-plate element 41 is at its lowest position and the pedal-plate element 42 is at its highest position with respects to the base B. The protrusion P is on top of the base B, mechanically coupled to the locking bar 50 and said locking bar 50 extends inside the hollow body of the main body 20. The second pivot element B2, which mechanically couples the protrusion P and said locking bar 50, is rotationally aligned with the first pivot element B1. In other word, the second pivot element B2 is not vertically nor horizontally aligned with the first pivot element B1 but the radius displacement in said first pivot element B1 is aligned with the radius displacement of the main body 20. As mentioned above, another feature of the space bar is to provide a vertical element which extends away from the main body for locking purposes. As shown in FIG. 9D, when the main body 20 is in horizontal position at least one two vertical elements' height extends vertically away from the main body 20.

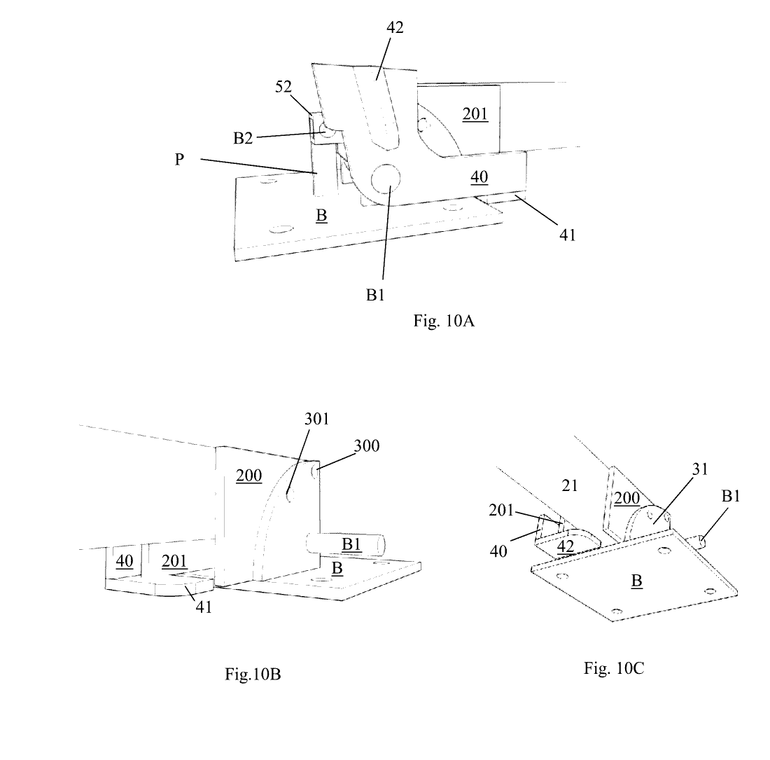

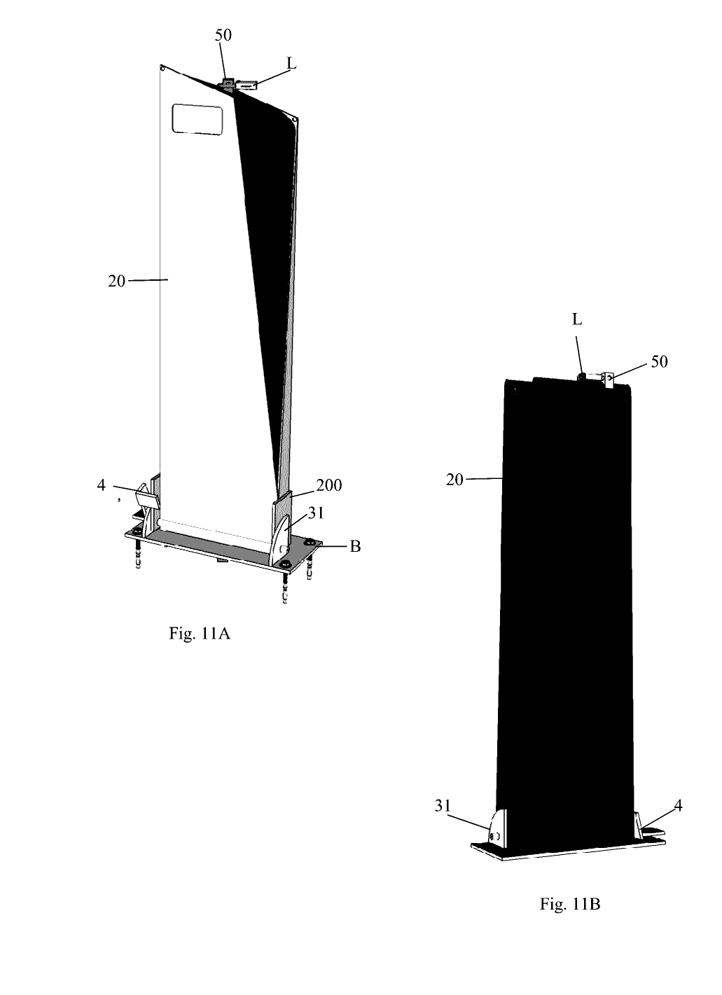

Another important feature, as shown in FIG. 10A through 10C, is the actuator 4 which assist the user to move the space barrier 1 into a vertical position for reserving spots, more particularly pulls up the main body 20 from a horizontal position to a vertical position. Mainly the actuator 4 comprises a pedal-plate element 42, a fixing plate 40 and a pull-plate element 41. The fixing plate 40 is mechanically coupled to the first pivot element B1. The pull-plate element 41 is fixed to the fixing plate 40 and extends perpendicularly and away from said fixing plate 40 towards the main body 20. The pull-plate 41 is intended to contact the main body 20 while the main body 20 is in horizontal position and transitional position, wherein said pull-plate 41 is located between the main body 20 and the base B and/or floor. The pedal-plate element 42 is fixed to the fixing plate 40 and extends vertically away from the fixing plate 40 and the main body 20. The purpose of the pedal-plate element 42 is to provide a surface wherein the user applies force using the foot and said force is transmitted to the pull-plate 41 which in turns pulls ups the main body 20 in order to achieved a vertical portion.

Further, FIG. 11A through 11B, shows different shapes for the main body 20. The actuator 4, similar to previous description, is intended to contact the main body 20 and pull up said main body 20. The main body is a hollow body wherein said locking bar 50 extends in the vertical position. A padlock L, as mentioned above, is used to lock the main body 20 in a vertical position.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A space barrier comprising:
a base;
a pivot member;
a first main body comprising a hollow body;
a locking bar mechanism;
a actuator;
wherein said first main body is mechanically coupled to said pivot member;
wherein said locking bar mechanism is mechanically coupled to said pivot member; and
wherein said actuator is mechanically coupled to said pivot member.

2. The space barrier as in claim 1, wherein said pivot member comprises a pivot element and at least a two vertical elements; and wherein said main body is located between said at least two vertical elements.

3. The space barrier as in claim 1, wherein said locking bar mechanism comprises a locking bar, wherein said locking bar displace inside said hollow body.

4. The space barrier as in claim 1, wherein said locking bar mechanism comprises a locking bar and pivot locking mechanism, wherein said pivot locking mechanism comprises a protrusion, wherein said protrusion is fixed to said base, wherein said protrusion is mechanically coupled to said locking bar.

5. The space barrier as in claim 1, wherein said actuator comprises a pedal-plate element, a fixing plate and a pull-plate.

6. The space barrier as in claim 5, wherein said pull-plate contact said main body; and wherein said pull-plate is configured to pull up said main body.
